(19) United States
(12) Patent Application Publication
(10) Pub. No.: US 2018/0336252 A1
(43) Pub. Date: Nov. 22, 2018

(54) Summarization of Large Histograms

(71) Applicant: SAP SE, Walldorf (DE)

(72) Inventors: Yogi Ramdas Joshi, Waterloo (CA); Anisoara Nica, Waterloo (CA); David E. DeHaan, Waterloo (CA)

(21) Appl. No.: 15/597,594

(22) Filed: May 17, 2017

(51) Int. Cl. G06F 17/30; G06F 21/62; H04L 29/06

(52) U.S. Cl. CPC G06F 17/30554; G06F 17/30598; H04L 63/10; G06F 21/6218; G06F 17/30412

(57) ABSTRACT

Disclosed herein are system, method, and computer program product embodiments for summarizing large histograms. In an embodiment, a client device may not have access to a full dataset stored in a secure system due to privacy or confidentiality restrictions. The secure system, however, may grant the client device access to a histogram related to the dataset as confidentiality may be maintained. Using this histogram, the client device may summarize the dataset to more efficiently utilize memory resources and/or more quickly execute queries. In an embodiment, the client device summarizes the original histogram into a form having fewer buckets than the original histogram. The client device also calculates new bucket boundaries using pairwise comparison and/or maxdiff algorithms.

### BACKGROUND

Database systems often organize and store large amounts of data and datasets. Database systems may calculate different statistics related to this stored data. In some instances, histograms may be computed and maintained to represent stored datasets. Generally, histograms are a representation of the data that partitions the stored data into different buckets grouped by a common variable. Histograms may include data statistics which summarize the stored dataset. Database systems may also assign a frequency value to each bucket of the histogram representing the number of attribute values contained in the bucket. Database systems may utilize histograms to estimate the number of potential results returned in response to a query. Using this estimate, database systems may better optimize the querying of the stored data by providing indications on the type of search that should be performed. For example, a database system may utilize a histogram to determine when to execute a full table scan versus an index scan of the stored dataset.

In real-word data applications, however, full datasets are sometimes unavailable. For example, privacy and/or confidentiality issues may prevent access to all of the information in a dataset. As a result, manipulation of this information becomes difficult.

Additionally, client devices may sometimes need to reconstruct histograms. For example, client devices may wish to reduce the storage space of large histograms to better utilize memory resources. Reconstructing histograms, in addition to optimizing query execution, is often difficult without having access to a full dataset.

### BRIEF DESCRIPTION OF THE DRAWINGS

The accompanying drawings are incorporated herein and form a part of the specification.

FIG. 1 is a block diagram of a histogram summarization system, according to some embodiments.

FIG. 2A is a flowchart illustrating a method for summarizing a histogram, according to some embodiments.

FIG. 2B is a flowchart illustrating a method for generating an output summarized histogram, according to some embodiments.

FIG. 3 is a flowchart illustrating a method for transmitting a histogram, according to some embodiments.

FIG. 4 is an example computer system useful for implementing various embodiments.

In the drawings, like reference numbers generally indicate identical or similar elements. Additionally, generally, the left-most digit(s) of a reference number identities the drawing in which the reference number first appears.

### DETAILED DESCRIPTION

Provided herein are system, apparatus, device, method and/or computer program product embodiments, and/or combinations and sub-combinations thereof, for large histogram summarization.

In an embodiment, even if data privacy and/or confidentiality issues prevent access to full datasets stored in secure systems client devices may be able to reconstruct histograms. In an embodiment, this reconstruction may take the form of summarization, which yields an output summarized histogram with fewer buckets. Developers may utilize the output summarized histogram to better improve or even optimize query execution, identify variation in error bounds during the estimation of query result sizes, and/or reduce the amount of memory resources needed to store a histogram representation of the underlying dataset.

In an embodiment, query execution in a client device may be too slow, and a developer may want to hasten the execution process. In some cases, confidential and/or private data may not be available due to privacy policies or customer agreements, preventing a developer from easily generating a histogram from the underlying dataset. Statistics related to the dataset, however, may be accessible and may be utilized for the purpose of query optimization. For database systems containing private and/or confidential data, providing statistics related to the data, rather than providing the data itself, still maintains confidentiality that protects against full access to the data. With these statistics, client devices may troubleshoot query optimization processes using a histogram, and confidential data may remain safely stored.

In an embodiment, a secure system is provided. The secure system may receive and/or store data that may be unavailable to client devices external to the secure system. The secure system may include a sever for network communication and processing and/or a database for data storage. The full dataset may be stored in the database but the server may restrict access to the data by systems external to the secure system. In an embodiment, this restriction may occur as a result of privacy policies and/or customer agreements. In an embodiment, the secure system may securely store confidential information related to customer accounts and/or purchases. The secure system may receive and store data from certain customers and/or client devices but may not allow access to the data from other customers and/or other client devices.

In an embodiment, rather than grant access to the full dataset, the secure system may grant access to statistics regarding the stored data. For example, a client device may request statistics regarding the distribution of the stored data. In an embodiment, the secure system may deliver distribution statistics in a histogram form. The secure system may transmit statistics such as bucket boundaries, distribution frequencies, and/or distinct value frequencies. Although the secure system may not provide access to the stored full dataset due to privacy or confidentiality restraints, the secure system may provide statistics related to the data which may still maintain privacy and confidentiality.

In an embodiment, the histogram and/or the statistics related to the histogram and underlying dataset may be summarized to allow for query optimization. The summarization may occur at a client device remote from the secure system and/or may occur at the secure system prior to the delivery of the histogram to a remote client. Summarizing histograms may allow for more efficient resource management, such as, for example, reduced memory usage. Efficient usage of main system memory, disk space, and network bandwidth is important when statistics are stored in metadata as metadata may require efficient read and write operations in order to ensure scalability in centralized and distributed settings. In an embodiment, reconstructing a histogram to produce a new histogram that includes a fewer number of buckets relative to the original histogram may yield more efficient memory usage. This reconstruction may aid in identifying variation in the error bounds during the estimation of query sizes relative to the variation in the number of buckets of the histogram. Reconstructing histograms without access to the full dataset, however, may require the development of other algorithms to more efficiently summarize the histograms.

In an embodiment, a histogram may be reconstructed for better query optimization or more efficient memory usage by utilizing the statistics related to the histogram. In an embodiment, these statistics may allow for more efficient summarization of the underlying dataset portrayed by the histogram without needing complete access to the underlying dataset.

In an embodiment, a method for summarizing a histogram may include receiving statistics related to the histogram. The histogram may be received at a client device from a secure system via a network connection. The histogram may include the number of buckets, the bucket boundaries, the number of data points falling within each bucket (i.e., distribution frequencies), and/or the number of distinct values associated with each bucket (i.e., distinct value frequencies). The number of desired buckets for the summarized histogram may also be received and/or determined. In an embodiment, the number of desired output buckets may be determined at a client device. The number of desired output buckets may be specified by a user and/or may be calculated as a result of a client device query optimization process. For example, the number of output buckets may correspond to a desired level of memory usage at the client device. In an embodiment, the number of desired output buckets is less than the number of original buckets of the histogram to aid in more efficiently utilizing the memory resources of the client device.

Depending on the provided histogram, the client device may process the histogram to generate a frequency data distribution and a vector of distinct frequencies. Together, the frequency data distribution and the vector of distinct frequencies may be referred to as an “aggregated frequency data distribution.” The frequency data distribution may be pairs of values matching a bucket boundary of the original histogram to a corresponding frequency for the original bucket. The frequency data distribution may match each of the buckets of the original histogram to its corresponding frequency. The vector of distinct frequencies may represent the number of distinct values associated with each original bucket.

Having determined the number of desired buckets and having analyzed the histogram, the client device may define new bucket boundaries for the buckets of the output summarized histogram. The new bucket boundaries may be defined utilizing the histogram. Some embodiments may use one or more pairwise comparison algorithms to determine the new bucket boundaries. The one or more pairwise comparison algorithms may include, for example, one or more maxdiff algorithms, regression algorithms, ranking algorithms, and/or other algorithms for generating histograms.

In some embodiments, the pairwise comparison algorithms may include one or more maxdiff algorithms, which may identify maximum differences in the dataset. These maxdiff algorithms may include any combination of:

Maxdiff Value Frequency, which places bucket boundaries based on the largest frequencies among all attribute values of the data distribution;

Maxdiff Split Value Frequency, which places bucket boundaries based on the largest changes in frequencies among all successive attribute values of the data distribution;

Maxdiff Value Density, which places bucket boundaries based on the largest densities among all successive attribute values of the data distribution;

Maxdiff Split Value Density, which places bucket boundaries based on the largest changes in the densities among all successive attribute values of the data distribution; and

Maxdiff Area, which places bucket boundaries based on the largest area parameters for the attribute values of the data distribution.

A client device may use one or more of these maxdiff algorithms to determine the bucket boundaries for the output summarized histogram. In an embodiment, a user and/or client device may specify which maxdiff algorithm to use. The user and/or client device may select among the maxdiff algorithms and may choose to select different maxdiff algorithms for different data distributions. In an embodiment, the user and/or client device may designate one or more maxdiff algorithms to use as a default maxdiff algorithm. In an embodiment, the client device may determine which maxdiff algorithm to apply based on query optimization and/or the histogram. For example, the client device may select a maxdiff algorithm based on testing and/or monitoring queries and query execution speeds. The client device may select a maxdiff algorithm based on the algorithm which allows for the most efficient execution of queries.

After selecting one or more maxdiff algorithms to apply, the client device may apply the one or more maxdiff algorithms to the histogram and determine the bucket boundaries for the output summarized histogram. The output summarized histogram may include the number of buckets initially desired. The client device may determine the boundaries for each bucket based on the application of the maxdiff algorithm. In an embodiment, to generate the output histogram, the client device may iterate over the buckets of the original histogram to determine which value frequencies are combinable in the output summarized histogram buckets. After determining the frequencies of each bucket of the output summarized histogram, the client device may store the output summarized histogram. The client device may then utilize the output summarized histogram when executing queries in order to more efficiently utilize memory resources when executing future queries relative to searching the original histogram. In an embodiment where the output summarized histogram contains fewer buckets relative to the original histogram, the client device expends less memory resources. This efficiency is important when statistics are stored in metadata because metadata requires efficient read and write operations in order to ensure scalability in centralized and distributed memory settings. Summarizing histograms even in the absence of full access to the underlying data thus allows for more efficient query execution.

These features will now be discussed with respect to the corresponding figures.

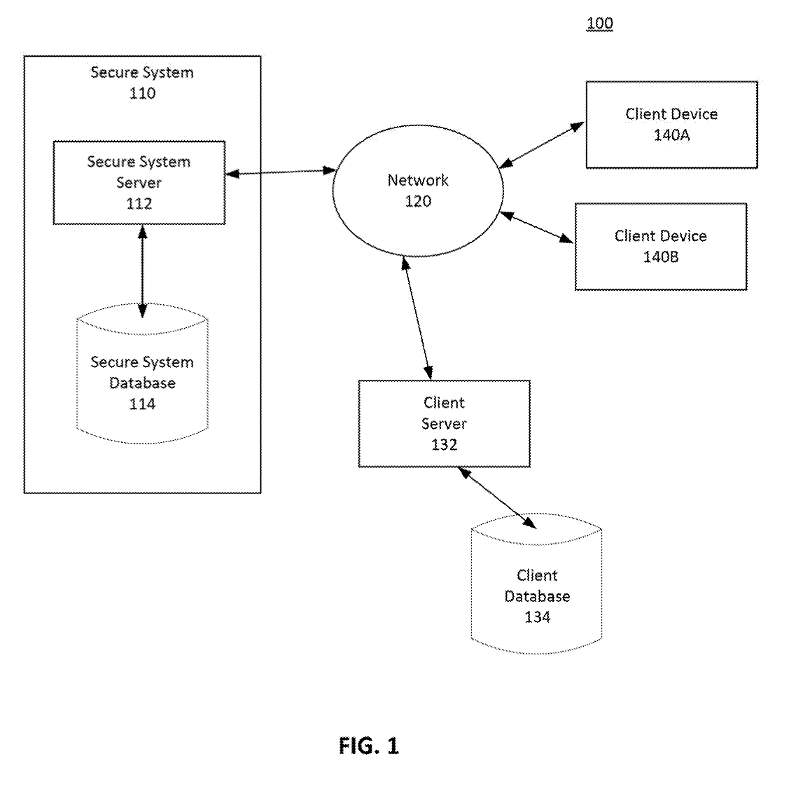

FIG. 1 is a block diagram of a histogram summarization system 100, according to some embodiments. In an embodiment, histogram summarization system 100 may include a secure system 110, a network 120, and client devices 140A-140B. Secure system 110 may communicate with client devices 140A-140B via network 120. Histogram summarization system 100 may also include a client server 132 and client database 134. Secure system 110 may communicate with client server 132 and client database 134 via network 120.

Secure system 110 may comprise one or more processors, computers, servers, databases, and/or memory devices. The hardware of secure system 110 may be configured to receive and/or store private and/or confidential information. In an embodiment, secure system 110 may include a secure system server 112 and a secure system database 114. Secure system server 112 may communicate with external devices via network 120. Network 120 may be any type of network capable of transmitting information either in a wired or wireless manner and may be, for example, the Internet, a Local Area Network, or a Wide Area Network. The network protocol may be, for example, a hypertext transfer protocol (HTTP), a TCP/IP protocol, Ethernet, or an asynchronous transfer mode.

In an embodiment, secure system 110 may receive confidential information from a client device 140. Client device 140 may be any type of computing platform, such as but not limited to smartphones, tablet computers, laptop computers, desktop computers, web browsers, or any other computing device, apparatus, system, or platform. Secure system server 112 may receive the confidential information from a client device 140 via network 120. Secure system 110 may then store this information in secure system database 114. In an embodiment, the private and/or confidential information may include, for example, data from business applications related to confidential business records, banking information, sales order information, national security information, customer account information, personal information related to users of client devices 140, and/or other private or confidential information.

In an embodiment, secure system 110 may receive private information from client device 140A. Secure system server 112 may receive the private information from network 120 and store the private information in secure system database 114. In an embodiment, secure system 110 may prevent access to the private information from client device 140B and/or client server 132 and may only grant access to the information to client device 140A as the client device 140 that submitted the information.

In an embodiment, secure system 110 may selectively grant access to private account information based on corresponding user accounts. For example, a user associated with a first user account may utilize client device 140A to store private information in secure system 110. The user associated with the first user account may then utilize client device 140B to access the private information. Based on a check of the user account information, secure system 110 may deliver the information to client device 140B as long as the user associated with the first user account is utilizing client device 140B. If client server 132, which is not associated with the first user account, attempts to access the private information associated with the first user account, however, secure system 110 will not relinquish the information. Similarly, if a user associated with a second user account attempts to utilize client device 140B or another client device 140, secure system 110 may prevent access to the private information associated with the first user account. In this manner, secure system 110 may securely store private information associated with different user accounts and only grant access to users associated with the user account that submitted the information. In an embodiment, client server 132 may also be associated with a user account in a manner similar to a client device 140.

In an embodiment, secure system 110 may aggregate private information from many client devices 140 and/or client servers 132. Although the aggregated private information may remain confidential and/or inaccessible, secure system 110 may be configured to provide statistics related to the underlying information. For example, in the case of customer order sales information, rather than providing specific details relating to each individual order, secure system 110 may be configured to provide the number of orders placed in a specific geographic region or the number of orders falling within a specified price range. In an embodiment, media content such as articles, audio files, and/or video files, to name a few examples, may be queried. In some embodiments, the media content or individual statistics regarding the media content may be deemed private or confidential, but statistics regarding the data as a set may be accessible. For example, the number of pieces of media content having a number of views within a specified range may be provided. In an embodiment, secure system 110 may generate and provide statistics related to aggregated bank accounts in a similar manner.

As a result of this aggregation, large amounts of data may be stored in secure system 110. This large amount of data may be queried by client devices 140 and/or client server 132. Querying the data using, for example, SQL queries, however, may be burdensome due to the large amount of data that must be searched to meet qualifying conditions. To reduce this burden, a histogram may be utilized to determine the most efficient query execution method (e.g., selecting an index scan instead of a full table scan). Histograms are especially useful when data may be skewed and/or when data lacks uniformity.

Histograms may group the data stored in secure system 110 into buckets based on commonalities. For example, a query from client device 140 may request the number of sales orders falling within different price ranges. Different buckets may represent different price ranges. For example, a query may request the number of submitted sales orders totaling more than $5 million. Only 3% of the data, however, may meet this criteria despite secure system 110 storing hundreds of thousands of entries. Utilizing a histogram, which groups the sales orders based on price ranges, secure system 110 and/or a client device 140 may determine that an index scan is more advantageous than a full table scan in this context. A histogram allows client device 140 and/or secure system 110 to predict the possible number of results of a query, allowing better optimization in determining how to most efficiently execute the query.

In an embodiment, to more quickly complete query execution, histograms may need to be reconstructed. Secure system 110 or a client device 140 may reconstruct a histogram. Reconstruction may include generating a new histogram which contains a different number of buckets than the original histogram. For example, the new histogram may utilize fewer buckets to utilize fewer memory resources.

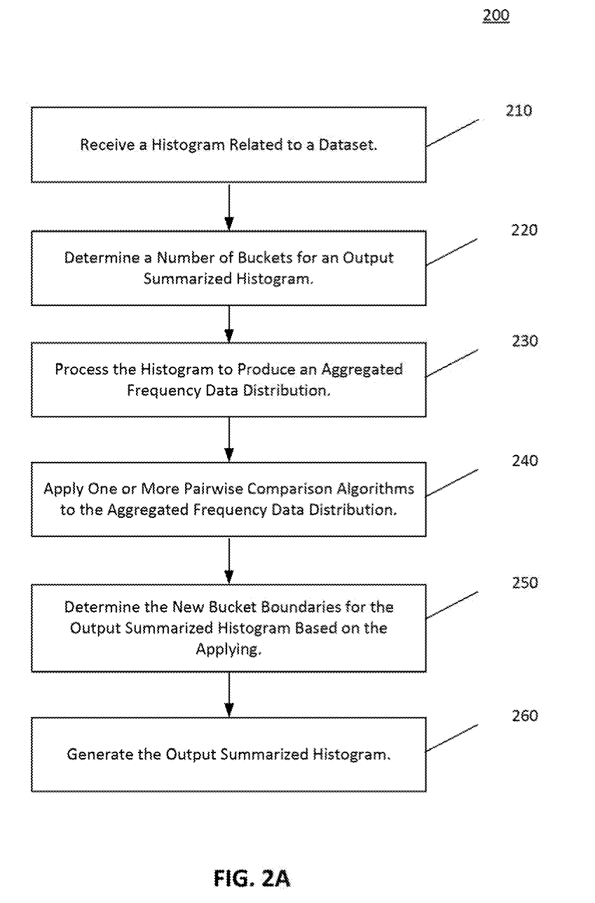

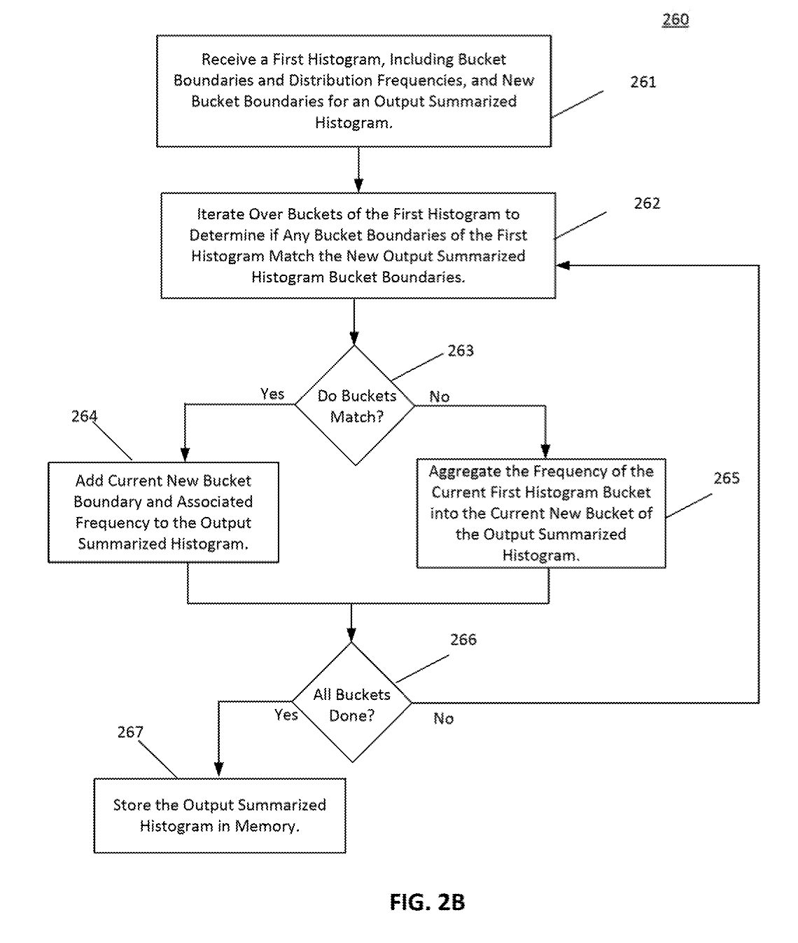

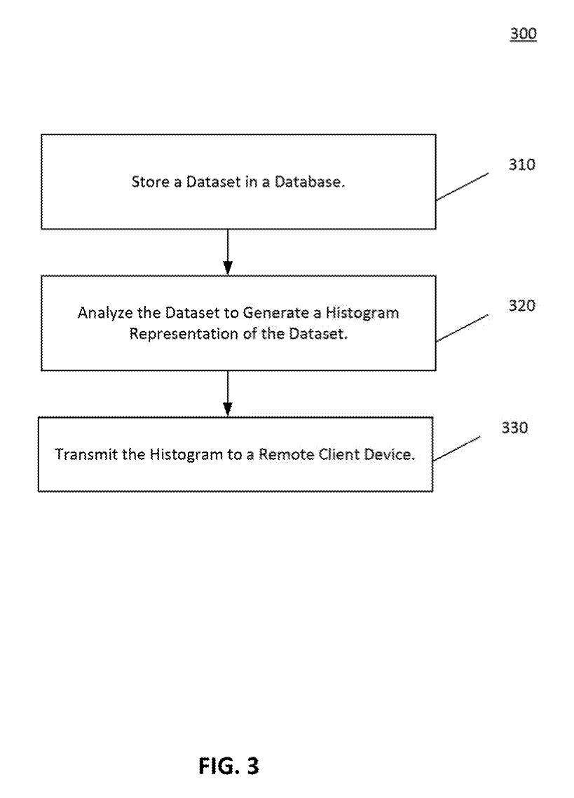

In an embodiment, a client device 140 and/or client server 132 may reconstruct a histogram of the data stored in secure system 110. Client device 140 and/or client server 132, however, may not be able to access the full dataset stored in secure system 110 due to privacy or confidentiality restrictions. In an embodiment, although the underlying data may be unavailable to a client device 140 and/or client server 132, secure system 110 may transmit a histogram, including the number of buckets associated with a first histogram, the bucket boundaries, the number of data points falling within each bucket (i.e., distribution frequencies), and/or the number of distinct values associated with each bucket (i.e., distinct value frequencies). Secure system 110 may transmit the histogram in a manner further described with reference to FIG. 3. Client device 140 and/or client server 132 may then receive the histogram and generate a new output summarized histogram. An embodiment of a method for generating a new output summarized histogram is described with reference to FIGS. 2A-2B. In an embodiment where the new output summarized histogram contains fewer buckets than the original histogram, a client device 140 and/or client server 132 may store and/or utilize the output summarized histogram. Storing and/or utilizing the output summarized histogram allows for more efficient main memory, disk space, and/or network bandwidth resource usage. Utilizing a fewer number of buckets also allows for greater efficiency when statistics are stored in metadata. When histograms are stored as metadata, more efficient read and write operations are needed to allow for scalability in centralized and distributed memory settings. In these respects, storing a histogram with fewer buckets uses fewer system memory resources.

FIG. 2A is a flowchart illustrating a method 200 for summarizing a histogram, according to some embodiments. Method 200 shall be described with reference to FIG. 1. However, method 200 is not limited to that example embodiment.

Secure system 110, client device 140, and/or client server 132 may utilize method 200 to summarize and/or reconstruct a histogram representation of data. In an embodiment, access to the underlying data stored in secure system 110 may be unavailable. In this situation, client device 140 and/or client server 132 may utilize method 200 to summarize and/or reconstruct a histogram even if client device 140 and/or client server 132 cannot access the underlying data. The foregoing description will describe an embodiment of the execution of method 200 with respect to client device 140. Client server 132 and/or secure system 110 may also execute method 200 in a similar manner.

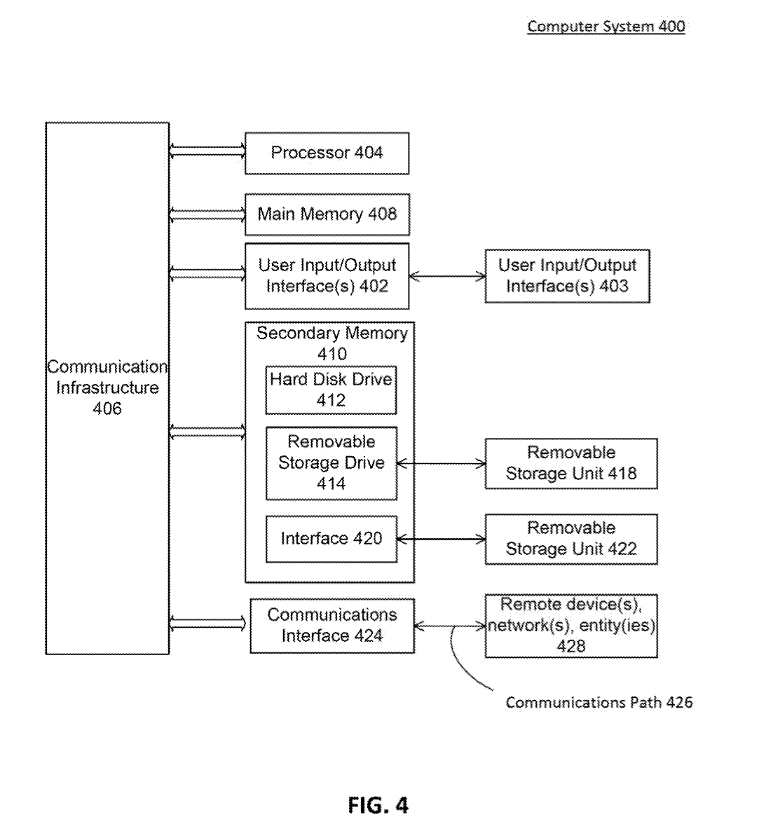

While method 200 may be described with reference to client device 140, method 200 may be executed on any computing device, such as, for example, the computer system described with reference to FIG. 4 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 2A, as will be understood by a person of ordinary skill in the art.

At 210, client device 140 may receive a histogram related to a dataset. Client device 140 may receive the histogram from a secure system 110 via a network 120. The histogram may include the number of buckets, the bucket boundaries, the number of data points falling within each bucket (i.e., distribution frequencies), and/or the number of distinct values associated with each bucket (i.e., distinct value frequencies). In an embodiment, client device 140 may receive a histogram and may process the histogram to determine statistics related to the histogram.

In an embodiment, secure system 110 may have generated a first histogram for executing queries and/or result estimation. Client device 140 may receive statistics related to the first histogram in response to a request sent from client device 140 to secure system 110. In an embodiment, secure system 110 may determine one or more client devices 140 that will receive the histogram and transmit the histogram to the determined client devices 140.

In an embodiment, client device 140 may receive a histogram data structure or metadata from secure system 110 and determine statistics related to the histogram based on the received histogram and/or metadata. In an embodiment, client device 140 does not receive the underlying dataset and/or any portion of the underlying dataset summarized by the first histogram.

At 220, client device 140 may determine the number of buckets for an output summarized histogram. In an embodiment, the client device 140 may receive a user input specifying the number of desired buckets for the output summarized histogram. Based on the context of the stored data and the desired optimization strategy, a user of client device 140 may use an input device to specify the desired number of buckets.

In an embodiment, client device 140 may calculate the number of desired output buckets based on the hardware and/or software resources available to client device 140. The number of buckets may correspond to a specific query optimization process. For example, the number of output buckets may correspond to a desired level of memory usage at client device 140. In an embodiment, the number of desired output buckets is less than the number of original buckets of the histogram to aid in more efficiently utilizing the memory resources of client device 140.

At 230, client device 140 may process the histogram to produce an aggregated frequency data distribution. Executing 230 may be optional when executing method 200 depending on the format of the received histogram at 210. If the received histogram is not in a form that matches a frequency to a bucket, 230 may generate this mapping by generating a frequency data distribution in the form of a table and/or metadata. The frequency data distribution may be pairs of values matching a bucket boundary of the original histogram to a corresponding frequency for the original bucket. The frequency data distribution may match each of the buckets of the original histogram to its corresponding frequency.

In an embodiment, client device 140 may also generate a vector of distinct frequencies at 140. The vector of distinct frequencies represent the number of distinct values associated with each original bucket. In an embodiment, these values may be received at 210 and may be processed into a vector form at 230. In an embodiment, the term “aggregated frequency data distribution” may refer collectively to the frequency data distribution and the vector of distinct frequencies.

At 240, client device 140 may apply one or more pairwise comparison algorithms to the aggregated frequency data distribution. The one or more pairwise comparison algorithms may include, for example, one or more maxdiff algorithms, regression algorithms, ranking algorithms, and/or other algorithms for generating histograms. At 250, client device 140 may determine the new bucket boundaries for the output summarized histogram based on the applying of the one or more pairwise comparison algorithms to the aggregated frequency data distribution.

In an embodiment, client device 140 may apply one or more maxdiff algorithms to the frequency data distribution. Depending on the maxdiff algorithm chosen, client device 140 may also apply the maxdiff algorithm to the vector of distinct frequencies.

Maxdiff algorithms may seek to identify maximum and/or largest differences in the dataset. The one or more maxdiff algorithms applied at 240 may include:

Maxdiff Value Frequency, which places bucket boundaries based on the largest frequencies among all attribute values of the data distribution;

Maxdiff Split Value Frequency, which places bucket boundaries based on the largest changes in frequencies among all successive attribute values of the data distribution;

Maxdiff Value Density, which places bucket boundaries based on the largest densities among all successive attribute values of the data distribution;

Maxdiff Split Value Density, which places bucket boundaries based on the largest changes in the densities among all successive attribute values of the data distribution; and

Maxdiff Area, which places bucket boundaries based on the largest area parameters for the attribute values of the data distribution.

Client device 140 may apply one or more of these maxdiff algorithms to the frequency data distribution and/or vector of distinct frequencies. Client device 140 may also determine the new bucket boundaries for the output summarized histogram. In an embodiment, a user may specify the maxdiff algorithm to be applied using client device 140. The user may select among the maxdiff algorithms and may choose to select different maxdiff algorithms for different data distributions.

In an embodiment, the user and/or client device 140 may designate one or more maxdiff algorithms to use as a default maxdiff algorithm. In an embodiment, client device 140 may utilize pre-assigned maxdiff algorithms based on an analysis of the aggregated frequency data distribution. Client device 140 may assign specific maxdiff algorithms to be applied based on the aggregated frequency data distribution. In an embodiment, client device 140 may determine which maxdiff algorithm to apply based on query optimization and/or the histogram. For example, client device 140 may select a maxdiff algorithm based on testing and/or monitoring queries and query execution speeds. Client device 140 may select a maxdiff algorithm based on the maxdiff algorithm which allows for the most efficient and/or fastest execution of queries.

In an embodiment, client device 140 may utilize “sort parameters,” or parameters whose value for each element in a data distribution is derived from the corresponding attribute value and frequencies. Sort parameters may include an attribute value and/or a frequency. In an embodiment, client device 140 may utilize “source parameters,” or parameters that denote a property of the data distribution useful for determining query size information. Source parameters may include a spread, frequency, area, and/or density.

For example, client device 140 may analyze a relation R with n numeric attributes Xᵢ where i=i . . . n. The value set Vᵢ of attribute Xᵢ is the set of values of Xᵢ that are present in R. Vᵢ may equal {vᵢ(k): 1≤k≤Dᵢ}, where vᵢ(k)<vᵢ(j) when k<j. The frequency fᵢ(k) of vᵢ(k) is the number of tuples in with Xᵢ=vᵢ(k), for 1≤k≤Dᵢ. The data distribution of the attribute Xᵢ is the set of pairs τᵢ=((vᵢ(1), fᵢ(1)), (vᵢ(2), fᵢ(2)), . . . , (vᵢ(Dᵢ), fᵢ(Dᵢ))}

Based on this definition the source parameters may be defined as:

The spread of sᵢ(k) of vᵢ(k) may be sᵢ(k)=vᵢ(k+1)−vᵢ(k), for 1≤k≤Dᵢ.

The frequency fᵢ(k) of vᵢ(k) is the number of tuples in with Xᵢ=vᵢ(k), for 1≤k≤Dᵢ.

The area aᵢ(k) of vᵢ(k) is may be aᵢ(k)=fᵢ(k)×sᵢ(k), for 1≤k≤Dᵢ.

The density dᵢ(k) of vᵢ(k) is may be dᵢ(k)=fᵢ(k)÷sᵢ(k), for 1≤k≤Dᵢ.

Using the sort parameters and source parameters, client device 140 may be able to select a maxdiff algorithm based on the aggregated frequency data distribution.

In an embodiment, at 250, after selecting one or more maxdiff algorithms to apply, client device 140 may apply the one or more maxdiff algorithms to the aggregated frequency data distribution and determine the bucket boundaries for the output summarized histogram. The output summarized histogram may include the number of buckets initially determined. Client device 140 may determine the boundaries for each bucket based on the application of the maxdiff algorithm.

In an embodiment, client device 140 may apply one or more pairwise comparison algorithms at 240 including algorithms other than a maxdiff algorithm. The one or more pairwise comparison algorithms may include, for example, one or more regression algorithms, ranking algorithms, and/or other algorithms for generating histograms. The one or more pairwise comparison algorithms applied may include one or more maxdiff algorithms or may not include a maxdiff algorithm. Based on the applied one or more algorithms at 240, client device 140 may determine new bucket boundaries based on the applied algorithm at 250.

At 260, client device 140 may generate the output summarized histogram. An embodiment of a method 260 for generating the output summarized histogram is discussed with reference to FIG. 2B. At 260, client device 140 may generate a new output summarized histogram and discard the data related to the original histogram and/or client device 140 may write the output summarized histogram over the original histogram data. In an embodiment, the output summarized histogram may take the place of the original histogram in the metadata of the memory of client device 140.

In an embodiment, at 260, a first bucket including the first bucket boundary of the original histogram may be determined. Client device 140 may then iterate over the buckets of the original histogram and the output summarized histogram buckets to determine which value frequencies are combinable in the output summarized histogram buckets. The output summarized histogram will then comprise the number of buckets determined at 220, grouping each of the frequencies into the newly determined bucket boundaries. After determining the frequencies of each bucket of the output summarized histogram, client device 140 may store the output summarized histogram. Client device 140 may then utilize the output summarized histogram when executing queries in order to more efficiently utilize memory resources when executing future queries relative to searching the original histogram. In an embodiment where the output summarized histogram contains fewer buckets relative to the original histogram, client device 140 expends less memory resources. This efficiency is important when statistics are stored in metadata because metadata requires efficient read and write operations in order to ensure scalability in centralized and distributed memory settings. Summarizing histograms even in the absence of full access to the underlying data thus allows for more efficient query execution.

### Example Embodiment

This section illustrates a non-limiting example execution of method 200. At 210, client device 140 may receive a histogram consisting of five buckets. The bucket boundaries for the received histogram may be {[5, 10), [10, 20), [20, 25), [25, 50), [50, 60]}, where a bracket represents a value included in the bucket and a parenthesis represents a value excluded from the bucket. For example, based on these buckets, the fourth bucket includes values ranging from 25 to 50 but excluding values equaling 50.

At 210, client device 140 may also receive frequency values associated with each bucket. For example, the frequencies associated with each bucket may be {10, 14, 5, 40, 30}, meaning the first bucket includes 10 values falling within the range (i.e., between five and ten but excluding ten), the second bucket includes 14 values falling within the range (i.e., between ten and twenty but excluding twenty), etc.

At 210, client device 140 may also receive distinct frequencies associated with each bucket. For example, the distinct frequencies associated with each bucket may be {3, 2, 5, 10, 6}, meaning the first bucket includes three distinct values, the second bucket includes two distinct values, etc.

At 220, client device 140 may determine that the desired number of buckets for the output summarized histogram is three.

At 230, client device 140 may process the histogram to produce an aggregated frequency data distribution. The aggregated frequency data distribution may correlate a bucket boundary to an associated frequency value. For example, the frequency data distribution may be τᵢ={(5, 10), (10,14), (20,5), (25,40), (50,30)}. The vector of distinct frequencies may be d_{f}={3, 2, 5, 10, 6}.

At 240, client device 140 may apply one or more pairwise comparison algorithms, including one or more maxdiff algorithms, to the frequency data distribution and/or the vector of distinct frequencies. For example, Table 1 below demonstrates calculations for applying the Maxdiff Value Density and Maxdiff Split Value Density algorithms.

TABLE 1

| Entry | Maxdiff Value Density | Maxdiff Split Value Density |
|---|---|---|
| (5, 10) | 2 | — |
| (10, 14) | 1.4 | 0.6 |
| (20, 5) | 1 | 0.4 |
| (25, 40) | 1.6 | 0.6 |
| (50, 30) | 1.818 | 0.182 |

If, for example, a user or client device 140 determines that Maxdiff Split Value Density is the optimum algorithm for determining the new bucket boundaries, the calculated values may be analyzed to determine the bucket boundaries. For the Maxdiff Split Value Density case, the largest changes occur at the (10,14) and (25,40) entries. This recognition also occurs due to the desired number of output summarized histogram buckets being three. At 250, client device 140 may use these values as bucket boundaries for the output summarized histogram.

At 260, after determining the bucket boundaries, client device 140 may generate the output summarized histogram. The output summarized histogram will comprise three buckets with boundaries of {[5, 10), [10, 25), [25, 60]}. Client device 140 also aggregates the frequencies for these buckets as {10, 19, 70}. Client device 140 also aggregates the distinct frequencies for these buckets as {3, 7, 16}.

Client device 140 may store the output summarized histogram for later use in query optimization.

FIG. 2B is a flowchart illustrating a method 260 for generating an output summarized histogram, according to some embodiments. Method 260 shall be described with reference to FIG. 1 and FIG. 2A. However, method 260 is not limited to that example embodiment.

Secure system 110, client device 140, and/or client server 132 may utilize method 260 to generate an output summarized histogram. The foregoing description will describe an embodiment of the execution of method 260 with respect to client device 140. Client server 132 and/or secure system 110 may also execute method 260 in a similar manner.

While method 260 may be described with reference to client device 140, method 260 may be executed on any computing device, such as, for example, the computer system described with reference to FIG. 4 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 2B, as will be understood by a person of ordinary skill in the art.

In an embodiment, a client device 140 may execute method 260 as part of the execution of method 200. In an embodiment, client device 140 may execute method 260 after completing the other executions of method 200. For example, client device 140 may execute method 260 after determining new bucket boundaries for an output summarized histogram. In an embodiment, client device 140 may execute method 260 as a standalone process without first executing method 200.

At 261, client device 140 may receive a first histogram, including bucket boundaries and distribution frequencies, and new bucket boundaries for an output summarized histogram. In an embodiment, client device 140 may have received the first histogram as a result of executing method 200. Client device 140 may have calculated the new bucket boundaries based on determining a desired number of output buckets and applying one or more pairwise comparison algorithms to the distribution frequencies. In an embodiment, client device 140 and/or a sub-component of client device 140 may receive the first histogram, including bucket boundaries and distribution frequencies and new bucket boundaries at 261.

In an embodiment, client device 140 may also initialize the creation of the output summarized histogram at 261. To initialize the creations of the output summarized histogram, client device 140 may first set the minimum bucket value of the output summarized histogram to equal the minimum bucket value of the original histogram. This value may be inclusive.

At 262 and 263, client device 140 may iterate over the buckets of the first histogram to determine if any of the bucket boundaries of the first histogram match any of the new output summarized histogram bucket boundaries. To construct the output summarized histogram, client device 140 may generate a new output summarized histogram and discard the data related to the original histogram and/or client device 140 may write the output summarized histogram over the original histogram data. In an embodiment, the output summarized histogram may take the place of the original histogram in the metadata of the memory of client device 140. Iterating over the buckets of the first histogram at 262 may allow for the construction of the output summarized histogram to take the place of the original histogram.

At 263, the bucket boundaries of the first histogram are iteratively compared to the bucket boundaries of the output summarized histogram to determine if the boundaries match. For example, the bucket boundaries of the first histogram may be {[15, 10), [10, 20), [20, 25), [25, 50), [50, 60]} while the bucket boundaries of the output summarized histogram may be {[5, 10), [10, 25), [25, 60]}. At 263, the bucket boundaries are iteratively compared. If the bucket boundary matches, method 260 executes 264. If the bucket boundary does not match, method 260 executes 265.

At 264, if the bucket boundaries match, client device 140 may add the currently compared new bucket boundary and associated frequency to the output summarized histogram. In an embodiment where the output summarized histogram is being written over the first histogram, client device 140 may keep the matching bucket boundary from the first histogram because the bucket boundary is equivalent. In an embodiment, at 264, client device 140 may also associate the same frequency value as previously listed in the first histogram.

For example, if a bucket of the first histogram comprises a range of {[5, 10)} and a bucket of the output summarized histogram also comprises a range of {[5, 10)}, client device 140 may utilize the first histogram bucket boundary at 264. Client device 140 may also associate the frequency of this range with the output summarized histogram.

At 265, if the bucket boundaries do not match, client device 140 may aggregate the frequency of the currently iterated first histogram bucket into the currently iterated new bucket of the output summarized histogram. Client device 140 may execute 265 in an embodiment where the number of histogram buckets of the output summarized histogram is less than the number of buckets of the first histogram.

Assume again in an example embodiment, the bucket boundaries of the first histogram may be {[5, 10), [10, 20), [20, 25), [25, 50), [50, 60]} while the bucket boundaries of the output summarized histogram may be {[5, 10), [10, 25), [25, 60]}. Examining the second bucket of the first histogram, the range specified is {[10, 20)}. The range of the second bucket of the output summarized histogram, however, is {[10, 25)}. Because these bucket boundaries do not match, at 265, client device 140 may aggregate the frequency of the second bucket of the first histogram into the second bucket of the output summarized histogram. In the next pass of the iteration, client device 140 may recognize that the third bucket of the first histogram {[20, 25)} shares a common upper bucket boundary with the second bucket of the output summarized histogram. {[10, 25)}. In this case, client device 140 may aggregate the frequency of the second and third buckets of the first histogram and associate the aggregated frequency with the second bucket of the output summarized histogram. For example, if the frequency of the second bucket of the first histogram was 14 and the frequency of the third bucket of the first histogram was 5, the associated frequency of the second bucket of the output summarized histogram would be 19. This number may represent 19 values falling within the range of {[10, 25)}.

At 266, client device 140 may determine if the output summarized histogram buckets have completed iteration such that each of the output summarized histogram buckets have an associated frequency. If not, method 260 may execute 262 to continue iterating over the buckets. If the buckets have completed iteration, method 260 may execute 267.

At 267, client device 140 may store the output summarized histogram and accompanying statistics related to the output summarized histogram. Client device 140 may store the output summarized histogram and accompanying statistics in memory and/or in metadata. This storage allows for later retrieval to aid in query optimization based on the summarized histogram.

FIG. 3 is a flowchart illustrating a method 300 for transmitting a histogram, according to some embodiments. Method 300 shall be described with reference to FIG. 1 and FIGS. 2A-2B. However, method 300 is not limited to that example embodiment.

Secure system 110 may utilize method 300 to generate and transmit a histogram. The foregoing description will describe an embodiment of the execution of method 300 with respect to secure system 110. While method 300 may be described with reference to secure system 110, method 300 may be executed on any computing device, such as, for example, the computer system described with reference to FIG. 4 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 3, as will be understood by a person of ordinary skill in the art.

At 310, secure system 110 may store a dataset in a database. In an embodiment, secure system 110 may private and/or confidential data from a client device 140 and/or a client server 132. The private and/or confidential data may be received at secure system server 112 and stored in secure system database 114. Aggregating the private and/or confidential data may form a dataset. In an embodiment, secure system 110 may store the dataset and restrict access to the dataset. For query optimization purposes, however, secure system 110 may be configured to provide statistics regarding the dataset.

At 320, secure system 110 may analyze the dataset to generate a histogram representation of the dataset. Similar to method 200 and 260 described with reference to FIGS. 2A and 2B, secure system 110 may generate a histogram with a desired number of buckets. In contrast to method 200, because secure system 110 may access the dataset stored within secure system 110, secure system 110 may generate a histogram based directly on the dataset itself. Having access to the dataset allows secure system 110 to tailor the histogram in a manner to best optimize query execution. The histogram also represents a data structure that maintains confidentiality, allowing secure system 110 to share the histogram without exposing all of the details of the underlying stored dataset.

At 320, secure system 110 may determine features of the histogram including the number of buckets, the bucket boundaries, the number of data points falling within each bucket (i.e., distribution frequencies), and/or the number of distinct values associated with each bucket (i.e., distinct value frequencies). Some of these features may be predetermined by secure system 110, such as, for example, the number of buckets. Other features, such as the distribution frequencies, however, may depend on the content of the dataset. In an embodiment, secure system 110 may determine that one or more features are private and/or confidential. For example, an administrator may designate certain features as protected and may prevent secure system 110 from transmitting confidential statistics to remote client devices. Secure system 110 may store these confidential features and may use these features when executing queries.

At 330, secure system 110 may transmit the histogram to a remote client device 140. In an embodiment, secure system 110 may transmit the histogram in response to a request sent by the client device 140 for a histogram. In an embodiment, secure system 110 may send the histogram to a predefined list of client devices 140. Secure system 110 may also periodically send one or more updated histograms to client devices 140 as dataset information changes. In an embodiment, client devices 140 may periodically query secure system 110 for an updated histogram. Secure system 110 may transmit a histogram to a remote client via a network 120.

In an embodiment, based on the privacy and confidentiality setting of secure system 110, a subset of a histogram may be sent to client devices 140. In an embodiment, secure system 110 may execute histogram summarization methods 200 and/or 260 and transmit output summarized histograms to client devices 140. In this embodiment, confidentiality features of secure system 110 may prevent the sending of certain histograms and/or subsets of a histogram to client devices 140. To provide a layer of security, however, secure system 110 may transmit summarized histograms in response to client device 140 requests. In an embodiment, secure system 110 may transmit summarized histograms to a client device 140 without first receiving a request from the client device 140.

Referring now to FIG. 4, various embodiments of can be implemented, for example, using one or more computer systems, such as computer system 400 shown in FIG. 4. One or more computer systems 400 (or portions thereof) can be used, for example, to implement methods 200 and 260 of FIGS. 2A and 2B.

Computer system 400 can be any well-known computer capable of performing the functions described herein.

Computer system 400 includes one or more processors (also called central processing units, or CPUs), such as a processor 404. Processor 404 is connected to a communication infrastructure or bus 406.

One or more processors 404 may each be a graphics processing unit (GPU). In an embodiment, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 400 also includes user input/output device(s) 403, such as monitors, keyboards, pointing devices, etc., that communicate with communication infrastructure 406 through user input/output interface(s) 402.

Computer system 400 also includes a main or primary memory 408, such as random access memory (RAM). Main memory 408 may include one or more levels of cache. Main memory 408 has stored therein control logic (i.e., computer software) and/or data.

Computer system 400 may also include one or more secondary storage devices or memory 410. Secondary memory 410 may include, for example, a hard disk drive 412 and/or a removable storage device or drive 414. Removable storage drive 414 may be a floppy disk drive, a magnetic tape drive, a compact disk drive, an optical storage device, tape backup device, and/or any other storage device/drive.

Removable storage drive 414 may interact with a removable storage unit 418. Removable storage unit 418 includes a computer usable or readable storage device having stored thereon computer software (control logic) and/or data. Removable storage unit 418 may be a floppy disk, magnetic tape, compact disk, DVD, optical storage disk, and/any other computer data storage device. Removable storage drive 414 reads from and/or writes to removable storage unit 418 in a well-known manner.

According to an exemplary embodiment, secondary memory 410 may include other means, instrumentalities or other approaches for allowing computer programs and/or other instructions and/or data to be accessed by computer system 400. Such means, instrumentalities or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 400 may further include a communication or network interface 424. Communication interface 424 enables computer system 400 to communicate and interact with any combination of remote devices, remote networks, remote entities, etc. (individually and collectively referenced by reference number 428). For example, communication interface 424 may allow computer system 400 to communicate with remote devices 428 over communications path 426, which may be wired and/or wireless, and which may include any combination of LANs, WANs, the Internet, etc. Control logic and/or data may be transmitted to and from computer system 400 via communication path 426.

In an embodiment, a tangible apparatus or article of manufacture comprising a tangible computer useable or readable medium having control logic (software) stored thereon is also referred to herein as a computer program product or program storage device. This includes, but is not limited to, computer system 400, main memory 408, secondary memory 410, and removable storage units 418 and 422, as well as tangible articles of manufacture embodying any combination of the foregoing. Such control logic, when executed by one or more data processing devices (such as computer system 4100), causes such data processing devices to operate as described herein.

Based on the teachings contained in this disclosure, it will be apparent to persons skilled in the relevant art(s) how to make and use embodiments using data processing devices, computer systems and/or computer architectures other than that shown in FIG. 4. In particular, embodiments may operate with software, hardware, and/or operating system implementations other than those described herein.

It is to be appreciated that the Detailed Description section, and not the Abstract section, is intended to be used to interpret the claims. The Abstract section may set forth one or more but not all exemplary embodiments as contemplated by the inventor(s), and thus, are not intended to limit the disclosure or the appended claims in any way.

While the disclosure has been described herein with reference to exemplary embodiments for exemplary fields and applications, it should be understood that the scope of the disclosure is not limited thereto. Other embodiments and modifications thereto are possible, and are within the scope and spirit of the disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments may perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein.

The breadth and scope of disclosed inventions should not be limited by any of the above-described exemplary embodiments, but should be defined only in accordance with the following claims and their equivalents.

What is claimed is:

1. A computer-implemented method, comprising:
receiving, at a client device, a histogram related to a dataset;
determining, by the client device, a number of buckets for an output summarized histogram;
processing, by the client device, the histogram to produce an aggregated frequency data distribution;
applying, by the client device, one or more pairwise comparison algorithms to the aggregated frequency data distribution;
determining, by the client device, new bucket boundaries for the output summarized histogram based on (1) the determined number of buckets for the output summarized histogram and (2) the applied one or more pairwise comparison algorithms; and
generating, by the client device, the output summarized histogram with the number of determined buckets and with the new bucket boundaries.

2. The computer-implemented method of claim 1, wherein the dataset is stored in a remote system configured to prevent the client device from accessing the dataset and wherein the histogram is received from the remote system.

3. The computer-implemented method of claim 1, wherein the one or more pairwise comparison algorithms includes one or more maxdiff algorithms.

4. The computer-implemented method of claim 1, wherein the histogram includes a first number of buckets and wherein the number of buckets for the output summarized histogram is less than the first number of buckets.

5. The computer-implemented method of claim 1, wherein the histogram includes a plurality of buckets, bucket boundaries for each bucket of the plurality of buckets, and a frequency associated with each bucket of the plurality of buckets.

6. The computer-implemented method of claim 5, wherein the generating the output summarized histogram further comprises:
comparing a bucket boundary of a first bucket of the histogram with a new bucket boundary for the output summarized histogram;
determining, based on the comparing, that the bucket boundary of the first bucket of the histogram does not match the new bucket boundary for the output summarized histogram;
in response to the determining, aggregating a frequency associated with the first bucket with a frequency of a second bucket of the histogram to produce an aggregated frequency value; and
associating the aggregated frequency value with the new bucket boundary for the output summarized histogram.

7. The computer-implemented method of claim 5, wherein the generating the output summarized histogram further comprises:
comparing a bucket boundary of a first bucket of the histogram with a new bucket boundary for the output summarized histogram;
determining, based on the comparing, that the bucket boundary of the first bucket of the histogram matches the new bucket boundary for the output summarized histogram;
in response to the determining, associating a frequency associated with the first bucket with the new bucket boundary for the output summarized histogram.

8. A system, comprising:
a memory; and
one or more processors coupled to the memory and configured to:
receive a histogram related to a dataset;
determine a number of buckets for an output summarized histogram;
process the histogram to produce an aggregated frequency data distribution;
apply one or more pairwise comparison algorithms to the aggregated frequency data distribution;
determine new bucket boundaries for the output summarized histogram based on (1) the determined number of buckets for the output summarized histogram and (2) the applied one or more pairwise comparison algorithms; and
generate the output summarized histogram with the number of determined buckets and with the new bucket boundaries.

9. The system of claim 8, wherein the dataset is stored in a remote system configured to prevent the one or more processors from accessing the dataset and wherein the histogram is received from the remote system.

10. The system of claim 8, wherein the one or more pairwise comparison algorithms includes one or more maxdiff algorithms.

11. The system of claim 8, wherein the histogram includes a first number of buckets and wherein the number of buckets for the output summarized histogram is less than the first number of buckets.

12. The system of claim 8, wherein the histogram includes a plurality of buckets, bucket boundaries for each bucket of the plurality of buckets, and a frequency associated with each bucket of the plurality of buckets.

13. The system of claim 12, wherein to generate the output summarized histogram, the one or more processors are further configured to:
compare a bucket boundary of a first bucket of the histogram with a new bucket boundary for the output summarized histogram;
determine, based on the comparing, that the bucket boundary of the first bucket of the histogram does not match the new bucket boundary for the output summarized histogram;
in response to the determining, aggregate a frequency associated with the first bucket with a frequency of a second bucket of the histogram to produce an aggregated frequency value; and
associate the aggregated frequency value with the new bucket boundary for the output summarized histogram.

14. The system of claim 12, wherein to generate the output summarized histogram, the one or more processors are further configured to:
compare a bucket boundary of a first bucket of the histogram with a new bucket boundary for the output summarized histogram;
determine, based on the comparing, that the bucket boundary of the first bucket of the histogram matches the new bucket boundary for the output summarized histogram;
in response to the determining, associate a frequency associated with the first bucket with the new bucket boundary for the output summarized histogram.

15. A tangible computer-readable device having instructions stored thereon that, when executed by at least one computing device, causes the at least one computing device to perform operations comprising:
receiving a histogram related to a dataset;
determining a number of buckets for an output summarized histogram;
processing the histogram to produce an aggregated frequency data distribution;
applying one or more pairwise comparison algorithms to the aggregated frequency data distribution;
determining new bucket boundaries for the output summarized histogram based on (1) the determined number of buckets for the output summarized histogram and (2) the applied one or more pairwise comparison algorithms; and
generating the output summarized histogram with the number of determined buckets and with the new bucket boundaries.

16. The tangible computer-readable device of claim 15, wherein the dataset is stored in a remote system configured to prevent the at least one computing device from accessing the dataset and wherein the histogram are received from the remote system.

17. The tangible computer-readable device of claim 15, wherein the one or more pairwise comparison algorithms includes one or more maxdiff algorithms.

18. The tangible computer-readable device of claim 15, wherein the histogram includes a first number of buckets and wherein the number of buckets for the output summarized histogram is less than the first number of buckets.

19. The tangible computer-readable device of claim 15, wherein the histogram includes a plurality of buckets, bucket boundaries for each bucket of the plurality of buckets, and a frequency associated with each bucket of the plurality of buckets, and wherein the generating the output summarized histogram further comprises:
comparing a bucket boundary of a first bucket of the histogram with a new bucket boundary for the output summarized histogram;
determining, based on the comparing, that the bucket boundary of the first bucket of the histogram does not match the new bucket boundary for the output summarized histogram;
in response to the determining, aggregating a frequency associated with the first bucket with a frequency of a second bucket of the histogram to produce an aggregated frequency value; and
associating the aggregated frequency value with the new bucket boundary for the output summarized histogram.

20. The tangible computer-readable device of claim 15, wherein the histogram includes a plurality of buckets, bucket boundaries for each bucket of the plurality of buckets, and a frequency associated with each bucket of the plurality of buckets, and wherein the generating the output summarized histogram further comprises:
comparing a bucket boundary of a first bucket of the histogram with a new bucket boundary for the output summarized histogram;
determining, based on the comparing, that the bucket boundary of the first bucket of the histogram matches the new bucket boundary for the output summarized histogram;
in response to the determining, associating a frequency associated with the first bucket with the new bucket boundary for the output summarized histogram.
